(19) United States
(12) Patent Application Publication
(10) Pub. No.: US 2006/0288280 A1
(43) Pub. Date: Dec. 21, 2006

(54) User-defined changing of page representations

(75) Inventor: Mikko Makela, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/433,915

(22) Filed: May 11, 2006

(30) Foreign Application Priority Data
May 11, 2005 (WO) PCT/IB05/01274

(51) Int. Cl. G06F 17/00; G06F 17/30

(52) U.S. Cl. 715/530; 707/1

(57) ABSTRACT

This invention relates to a method for generating a changed representation of a page object, wherein the page object is one of a page and a part of the page, the method comprising retrieving (201; 301) the page object in response to a request (200; 300) for the page; dividing (203; 303) the page object into a set (4a) of sections; and performing (204; 304) changes to the set (4a) of sections according to preference information to obtain a changed set (4b) of sections representing the changed representation of the page object. This invention further relates to a device, a system, a computer program and a computer program product for generating a changed representation of a page object.

### CROSS REFERENCE TO RELATED APPLICATION

This application claims priority under 35 USC §119 to International Patent Application No. PCT/IB2005/001274 filed on May 11, 2005.

### FIELD OF THE INVENTION

This invention relates to a method, a computer program, a computer program product, a device and a system for generating a changed representation of a page object, wherein said page object is one of a page and a part of said page.

### BACKGROUND OF THE INVENTION

The ongoing miniaturization of multi-media devices such as Personal Digital Assistants (PDAs), lap-top computers or mobile phones in recent years appears to be only bounded by the perceptual limits of the human user. This particularly applies to the design of the displays of multimedia devices, with a remarkable trend to increase the relative area of the device that is consumed by its display. However, the display sizes of, for example, hand-held devices are necessarily significantly smaller than the display sizes for which content is usually designed. If for instance content of the World Wide Web (WWW), i.e. web pages formatted according to the Hypertext Markup Language (HTML) or derivatives thereof (such as Extensible HTML (XHTML)), is to be displayed on the display of a hand-held device, it has to be considered that these web pages normally have an original presentation size designed for portrayal on a computer monitor, the dimensions of which are often remarkably larger than the display dimensions of a hand-held device.

State-of-the-art browsers that are installed in hand-held multi-media devices and provide for the interpretation of the web page content offer different techniques to view large web pages on small displays.

Probably, the most straightforward technique for viewing large web pages on small displays is to display a web page in its original layout, for instance with 100% zoom factor. Objects of said web page then have the size (in pixels or inches) that is prescribed by the object format (e.g. image or text format) and/or the markup language. For instance, if an image in the web page is defined to have a size of 40×40 pixels, it will also be displayed by 40×40 pixels of the display of the hand-held device, even if the hand-held device only has a display area of 176×208 pixels at all. In this original layout mode, as the web page area is big, and as only a fraction of the web page area fits into the small display, a lot of panning and zooming is needed to explore the entire content of the web page. Furthermore, on a small display, it is difficult to figure out the structure of a large page, i.e. the viewer may lose an overview of the entire web page. According to a further technique for viewing large web pages on small displays, which is disclosed in US patent application number 2004/0103371, a large web page is analyzed and partitioned into smaller sub-pages so that a user can navigate the web page on a device with a small display. The user can then browse the sub-pages to find and read information in the content of the large web page. After sub-page generation, an image index page is created to assist a user in navigating the web page. The image index page is marked with sub-pages, each of which is made up of one or more regions of the web page. When browsing, the user will first view a thumbnail rendering of the image index page. Then, in a bi-level browsing convention, the user can click on one of the marked sub-pages on the thumbnail of the image index page to go to the desired sub-page. Alternatively, the user's historical browsing habits for the web and for particular web pages can be analyzed to prioritize the first sub-page that the user will see when requesting a web page.

When browsing a web page, a user might need information from multiple regions of the web page, for example news headlines from the top of a page and a local weather report that is located at the bottom of a page. For both prior art techniques for viewing large web pages on small displays discussed so far, this requires a significant amount of extra navigation.

Furthermore, web pages may contain regions that do not contain any useful information for the user, like for instance advertisements, or news related to fields that the user is not interested in, or programs of television channels that the user does not want to watch, to name but a few.

Finally, the formatting of some regions of a web page may not be satisfying a user, for instance if a text font is unreadable because it is too small or has a background color that makes reading the text impossible.

US patent application number 2003/0005002 discloses a method for defining a composite web page, which method includes identifying a web page which references at least one associated element, analyzing the web page to determine a list of the associated elements, presenting the list of associated elements to a user, and receiving a user selection of one or more of the associated elements from the list. The selected elements are intended to be displayed on a composite web page. The user selection is registered or stored for later reference so that a user can retrieve the composite web page without having to redefine it.

However, according to this method for defining a composite web page, the entire composite web page, i.e. the definition of all elements of said composite web page, has to be stored either locally or on a remote server, and there exists no association between the composite web page and the original web page, so that a user, when desiring to view the composite web page, has to explicitly request said composite web page.

### SUMMARY OF THE INVENTION

In view of the above-mentioned problem, it is, inter alia, an object of the present invention to provide an improved method, computer program, computer program product, device and system for generating a changed representation of a page object, in particular a large page.

It is proposed a method for generating a changed representation of a page object, wherein said page object is one of a page and a part of said page, said method comprising retrieving said page object in response to a request for said page; dividing said page object into a set of sections; and performing changes to said set of sections according to preference information to obtain a changed set of sections representing said changed representation of said page object.

Said page may be any object that lends itself for visual presentation, for instance a web page, or a page of a document, a computer desktop, an application view, an image or video, a slide of a presentation, a three-dimensional (3D) presentation of an object like a 3D map, or any other type of presentable object. Said page may for instance be defined by a markup language, as for instance the Hypertext Markup Language (HTML), or by any other format suited for the type of the page, as for instance a text format or a graphics format. Said page may also be any combination of different types of objects, for instance a calendar view that has an image for every month.

In response to a request for said page, which may for instance be triggered by a user, a page object is retrieved. Said page object is either said complete page, or a part of said page. Thus said page does not necessarily have to be retrieved completely. Said request for said page may contain an identification of said page, as for instance a Uniform Resource Locator (URL) in the context of web pages stored in Internet nodes. Said retrieving may for instance be accomplished by loading said page object from a local (e.g. a hard disc) or external data source (e.g. a server). For instance, if said page object is to be displayed on a client of a network such as for instance the Internet, said page object is downloaded from an Internet server via several Internet nodes. Said retrieving may also comprise the transfer of said page object via a wireless interface, for instance if said client is a mobile phone in a mobile communications system the core network of which is connected to the Internet. Said retrieving may furthermore comprise an at least temporary local storage of said page object.

Said page object (i.e. said page or said part of said page) is then divided into a set of sections. This may for instance be accomplished by means of a sectioning algorithm, which element-wise renders the elements of said page object and generates sections of one or more of said rendered elements. Said set of sections may contain the complete information of said page object. However, some information of said page object may be lost during said dividing of said page object into said set of sections. Said dividing may target to generate sections with pre-defined dimensions, for instance the dimensions of a display on which said page object may be displayed, or with a pre-defined amount of information. It may also be possible that said dividing is performed according to a content analysis or a structure analysis of said page object.

According to preference information, changes are then performed to said set of sections. This yields a changed set of sections, which then represents a changed representation of said page object. Said changes of said set of sections may for instance comprise reordering, zooming, hiding, deleting, reformatting and/or creating sections in said set of sections. Said changes are performed according to preference information, which may for instance reflect how a user prefers a page to be presented. Equally well, said preference information may be defined by a third person, for instance another user or a service provider. Therein, said preference information may for instance have been defined during a previous request of a user for said page and then stored for later requests of said page, in which then said changes may be automatically performed without user interaction. Equally well, said preference information may be defined without a previous request for said page. This may for instance be the case when said preference information is a search criterion, according to which at least a part of a page is re-arranged. This search criterion then may be defined in general for all pages that are requested, or for certain types of pages, or during or after a request of a specific page, wherein then an adaptation of said search criterion to said requested page is possible.

According to the present invention, when said page object (i.e. said entire page or a part thereof) is retrieved in response to a request for said page, said page object is divided into said set of sections, and changes are applied to said set of sections in accordance with said preference information to obtain said changed set of sections. Said changed set of sections then represents a changed representation of said page object, and may for instance be presented or stored or otherwise processed, for instance by displaying a representation of said changed set of sections on a display. Thus said preference information, once defined, may allow for generating a changed representation of said page object without user interaction. The information required to perform the changes to said set of sections may be entirely contained in said preference information, so that, when a change of said representation of said page object is desired, not necessarily a changed version of said representation of said page object has to be stored and then retrieved from the stored version; instead, according to the present invention, the preference information is defined and then applied to said set of sections said page object has been divided into.

If said changes refer to a reordering of sections in said set of sections, said preference information may for instance contain information on the new position of sections in said changed set of sections. Equally well, said preference information may contain information for a pre-defined change algorithm, for instance a keyword or search criterion as input for a change algorithm that re-orders sections in said set of sections according to the degree they match said search string.

The present invention thus allows to change a representation of a page object. When said page object is a large page, which is to be displayed on a small display, the present invention particularly contributes to reducing an amount of navigation that is required to explore the contents of said large page on said small display. For instance, sections of said large page that are frequently viewed may be grouped together to reduce a distance between them and thus to reduce the amount of scrolling that is required to view them. In contrast to prior art techniques, not a changed version of said large page has to be stored and referred to later on, but only the preference information that contains information on the changes of said large page are stored. The changes are then applied to said page when said page object (either said entire page or a part thereof) is retrieved.

The steps of retrieving said section in response to said request, dividing said page into a set of sections and performing changes to said set of sections according to preference information to obtain said changed set of sections may be jointly performed in one device only, as for instance in a mobile phone, but may equally well be separately performed in two or more devices; said steps may for instance be distributed among nodes of a network such as a telecommunications network, wherein said nodes are connected by means of a wired or wireless connection.

According to an embodiment of the method of the present invention, said preference information is associated with said page and is automatically retrieved upon said retrieving of said page object. When a page is requested, said page object is retrieved from a page source, the corresponding preference information is determined based on said association, and said preference information is retrieved from a preference information source, which may for instance be a remote memory or a local memory in a device in which said page object is to be displayed. Said association may for instance be represented by a look-up table that assigns an identifier of a page to an identifier of the corresponding preference information or said corresponding preference information itself.

Preference information does not necessarily have to be associated with a single page only, it may also be associated with several pages at a time. For instance, the same preference information may be associated with all or some pages of an Internet site (e.g. all pages of the domain “www.nokia.com” or all pages of the path “www.nokia.com\phones”), or with all pages in a folder of a file directory (e.g. all files in folder “c:\MyLargePages”). Equally well, different types of associations may be combined, for instance a first portion of preference information may be associated on a site-level, and a second portion of said preference information may be associated on a path-level.

Furthermore, said association between preference information and pages may be based on content of pages; for instance, the same preference information may be associated with those pages that contain information related to the same topic, for instance “phones”. This may for instance be determined simply by counting appearances of the keyword “phone”, or with some smarter algorithm that for instance can find semantic similarities between pages, for instance like algorithms used with e-mail spam filters that can learn what kind of e-mails the user sees as spam and can then filter similar messages. In addition to semantic analysing, also other means like visual pattern recognition may be used to find similarities between pages to define associations. By this kind of association, for instance pages related to the same subject of interest can be made to look similar.

Equally well, association may be manually defined by a user, and then matching pages/sites/paths may be automatically determined. Also systems used by search engines like “Google” can provide information of which pages contain similar content and/or are related to each other, and such information can be used to define associations between preference information and pages as well.

According to a further embodiment of the method of the present invention, said preference information is stored together with bookmark information concerning said page. Said bookmark information may for instance comprise an address where said page can be retrieved, for instance a URL in case of a web page, and a title for the bookmark.

Said preference information may be stored upon user interaction, for instance, if a user stores a bookmark, said preference information is stored together with the bookmark information. It may also be possible that said preference information is stored automatically, for instance, when preference information is defined, a bookmark may be generated, containing bookmark and preference information.

In addition to normal bookmarks, also “adaptive bookmarks” may be used to store preference information. Adaptive bookmarks are stored automatically after visiting a page, and then automatically organized based on how often/recently the user has visited a certain page.

According to a further embodiment of the method of the present invention, said changes to said set of sections according to said preference information are performed automatically. Then the only user interaction required may be the request for said page, whereas the retrieving of said page object, the dividing into a set of sections, and the performing of changes is performed without further user interaction. Alternatively, a user may be asked if said changes are to be performed to said set of sections or not.

According to a further embodiment of the method of the present invention, said page is requested at least two times, in response to a first request, a defining of said preference information is performed, and in response to a second request, said steps of retrieving said page object, dividing said page into said set of sections, and performing changes to said set of sections to obtain said changed set of sections are performed. A user may then for instance request a page, may determine that changes are required for said page object retrieved in response to said request in order to fit his/her preferences, and may define said changes, that may be stored in the preference information. When requesting said page for the next time, the changes defined by the preference information then may be automatically applied to said page object retrieved in response to said repeated request and do not necessarily have to be defined again.

Before storing changes to preference information, the user may be asked for confirmation on whether to store changes or not. Alternatively, changes may be stored automatically, for instance so that the last used values are stored automatically. There may also be multiple sets of preference information, for instance for different users of the same device. Also meta data may be stored, for instance about the time when a section was moved to a different location. This may be used for instance for “undo” functionality so that the user can later remove changes step by step.

Said defining of said preference information may comprise dividing said page object into a set of sections; presenting a representation of said set of sections; performing changes to said set of sections to obtain a changed set of sections; and storing information on said changes to said set of sections in said preference information. The step of presenting (for instance displaying) a representation of said set of sections allows the user to decide if changes to said set of sections are required or not. If such changes are found to be required, they can be directly performed based on said presented representation of said set of sections. Therein, said dividing of said page object into a set of sections in response to said first request is advantageously performed with a sectioning algorithm that produces substantially the same results as a sectioning algorithm that is used for the dividing of said page into said set of sections in response to said second request.

Said information on said changes may for instance be automatically determined and stored in said preference information. Alternatively, information on said changes may be determined and stored upon user interaction.

It may be advantageous that said information on said changes stored in said preference information can be reset by a user. Resetting preference information may for instance be required if a user is no longer satisfied with his/her changes to said set of sections of a page, or if a page has been amended by a page author, so that the preference information no longer applies to the amended page.

According to a further embodiment of the method of the present invention, said performing of changes to said set of sections to obtain said changed set of sections comprises at least one of reordering, zooming, hiding, deleting, reformatting and creating at least one section in said set of sections. Said sections in said set of sections thus can be reordered and/or zoomed and/or hidden and/or deleted and/or reformatted and/or created. For instance, sections with content that is not relevant for a user may be hidden or deleted, sections with most interesting content may be grouped together and moved to a position in said set of sections where they can be inspected without requiring much navigation, for instance to a topmost or centred position, and ill-defined sections, for instance badly readable text sections, may be reformatted to allow for better readability. As an alternative or addition to the aforementioned techniques of performing changes to said set of sections, sections with relevant content may be assigned a larger zoom factor than sections with non-relevant content. Thus different sections of said changed set of sections may have different zoom factors, and the zoom factor may depend on the relevance of the content of a section or on other criteria. Assigning different sections of said set of sections different zoom factors may be an advantageous alternative to hiding or deleting sections. This alternative has the advantage that the (non-relevant) content of sections with smaller zoom factors is still basically visible, so that a user may react to changes in said content. For instance, if the content appears to become relevant for the user after a change, the user may increase the zoom factor of the corresponding section again. Such a control of the content of non-relevant sections may not be possible when the sections with non-relevant content are hidden or deleted. The user may also add new sections, or add/remove/edit content of sections. This is useful for instance if the user wants to organize page better and add headers to sections. Performing said changes on section basis may significantly reduce the amount of information on said changes that may have to be stored in said preference information. Furthermore, performing changes based on sections, which are automatically defined according to the present invention in the process of dividing said page object into said set of sections, unburdens the user from the need to define regions in said page object before actually being able to perform changes.

Changes to said set of sections may also be performed in order to reduce the amount of received data: the user may for instance define that for a certain section, images and/or objects (such as macromedia flash objects) are not downloaded at all, or a system may automatically define that for a certain section, images and/or objects are not downloaded at all. This may be done for instance based on the size of section; for hidden, deleted or very small sections images and/or objects then may not be downloaded as they would not be useful to the user. If a hidden, deleted or very small section then becomes visible/bigger either based on user interaction or automatically, its images and/or object may be downloaded automatically.

Said preference information advantageously contains information on said changed set of sections on a section basis. For one or more sections, then for instance information related to a position of said sections in said changed set of sections may be stored, and if said changed set of sections is only a reordered version of said set of sections, said information related to said positions may be the only information that needs to be stored in said preference information. Therein, also information about the sections in the original set of sections may be contained in said preference information, for instance to be able to recognize one or more sections in said changed set of sections.

Said information related to a section in said changed set of sections may for instance comprise at least one of information related to the position of said section in said changed set of sections, a size of said section in said changed set of sections, a zoom factor of said section in said changed set of sections, a presence of said section in said changed set of sections, a scale of said section in said changed set of sections, a format of said section in said changed set of sections, and a content of said section in said changed set of sections. Said size may for instance indicate an absolute or relative size of a section (for instance in pixels), and/or if said section has been cropped. Said zoom factor may for instance indicate that a section has to be displayed larger than other sections. Consequently, there may also exists different zoom factors for different sections. Said presence may for instance indicate if a section is hidden or deleted in said changed set of sections or not. Said scale may for instance indicate if a section is shown in small-scale or large-scale presentation, if a displaying of sections in either said small-scale or large-scale presentation is possible. Said format may for instance refer to a text font and/or background colour of a section, or to similar formatting of content of a section. Said content of said section may be particularly advantageous if new sections are created.

Said content may also comprise meta content, for instance if a content author has wrote descriptions for portions of a page. Furthermore, said information related to a section in said changed set of sections may also comprise information of a position of a section in said original set of sections. This may also be particularly advantageous if new sections are created. Said information related to a section in said changed set of sections may also contain an indication that no changes are required for this section. This would mean that a section is presented as if it would be presented in the original set of sections. Said indication that no changes are required for this sections then may for instance be embodied by storing no preference information for this section.

According to a further embodiment of the method of the present invention, a sectioning algorithm is used to divide said page object into said set of sections, and said sectioning algorithm is based on element-wise rendering of elements of said page object and on appropriate combining of said rendered elements into said sections. In case of said page object being a web page defined in HTML, said sectioning algorithm may for instance element-wise render the HTML elements of said web page and attempt to form rectangular sections out of said rendered HTML elements.

According to a further embodiment of the method of the present invention, said method further comprises presenting a representation of said changed set of sections. Said representation may for instance be a scaled and/or display-optimised version of said changed set of sections. Said presenting may for instance be a displaying of said representation, for instance on a display or by means of a projector.

According to a further embodiment of the method of the present invention, said presenting of said representation of said changed set of sections comprises presenting said changed set of sections in a small-scale presentation mode; and presenting at least one section out of said changed set of sections in a large-scale presentation mode, if said at least one section is selected by a user during said presenting of said changed set of sections in said small-scale presentation mode. Said small-scale presentation mode may for instance be a presentation mode in which said changed set of sections is scaled so that is fits at least one dimension of a display. Said large-scale presentation mode may be characterised in that a size of a section, compared to its size in the small-scale presentation mode, is significantly larger. In said small-scale presentation mode, said sections may for instance be displayed as thumbnails, and upon selection of at least one of said thumbnails, the corresponding section is shown enlarged, possibly together with further sections in small-scale and/or large-scale presentation mode.

Said set of sections said page object is divided into may for instance be a set of first-type sections, and said presenting of said representation of said changed set of first-type sections comprises dividing said changed set of first-type sections into a set of second-type sections; presenting said set of second-type sections in a small-scale presentation mode; and presenting at least one second-type section out of said set of second-type sections in a large-scale presentation mode, if said at least one second-type section is selected by a user during said presenting of said set of second-type sections in said small-scale presentation mode. It may be advantageous to have different sets of sections for performing changes to said page object on the one hand, and for displaying the changed representation of said page object on the other hand. However, it may be advantageous that the sectioning algorithms that are used in the context of the definition of changes for a set of sections and in the context of the performance of changes to a set of sections are the same or at least produce substantially equal results.

It may be advantageous that a first sectioning algorithm is used to divide said page object into said set of first-type sections, and wherein a second sectioning algorithm is used to divide said changed set of first-type sections into said set of second-type sections, and wherein said first and second sectioning algorithms are different. Therein, said sectioning algorithms are also understood to be different if they execute the same commands, but are operated with different parameters.

According to a further embodiment of the method of the present invention, in said presenting of said representation of said changed set of sections, at least one section out of said changed set of sections is accentuated, and wherein said at least one accentuated section is a relevant section that is specified in said preference information.

Said accentuation may be performed both in said small-scale presentation mode and in said large-scale presentation mode.

Accentuation of one or more sections may for instance be accomplished by initially presenting at least one section out of said changed set of sections in a large-scale presentation mode. Then, instead of presenting thumbnails of the sections of said page object and showing sections in large-scale presentation mode after their selection by a user, initially at least one section may be presented in large-scale presentation mode (possibly together with other sections that are shown in small-scale and/or large-scale presentation modes).

In said small-scale presentation mode, accentuation of one or more relevant sections may for instance be achieved in the following manner: an icon indicating relevance may be shown on a section, or a colour of a section may change according to its relevance, or a number indicating relevance rating may be shown on a section, or a size of a section may vary according to its relevance. When relevance gets really small, the section may be hidden, and when relevance gets high enough, the section may be initially shown in large-scale presentation. As further alternatives, a sharpness of a section may be changed, for instance, less relevant sections may be shown as blurred.

Different sections (for instance the most relevant section) may be indicated to the user also with other than visual means, for instance so that when accentuation arrives onto the most relevant section, a short sound may be played, or a short vibration may be triggered.

According to a further embodiment of the method of the present invention, a user-related relevance of at least one section is automatically determined and stored in said preference information.

Said user-related relevance may for instance be determined by determining the section that has been most frequently and/or most recently selected by a user for displaying in said large-scale presentation mode. Both criteria may be combined to determine relevance of sections to a user, for instance a mathematical formula may be used, in which formula these criteria are presented as variables. To determine the most frequently and/or most recently selected section or sections, an instance may be required that tracks the frequency and/or history of selections of single sections of pages.

Determining how frequently and/or recently one or more sections have been shown in large-scale presentation is only one way to determine relevance of sections. For instance, if the user views pages on a device with big display (big screen PDA or such) the page may be shown in its original layout, so the user may not need to separately select sections for presentation in large-scale presentation mode. Nevertheless, the page may be sectioned in the background, and the method may determine on which sections the user spends most time and/or which sections the user interacts with (selects links etc.). Based on this information, relevance of sections may be automatically determined and stored as preference information. This kind of determination of relevance may also be needed when the user uses pages on which some or all sections are initially shown in large-scale presentation mode; relevance of those sections the user spends least time on and/or interacts least with is then determined to decrease. One use case for this is also the situation when the user uses many different devices (for instance big screen handhelds and small screen handhelds) to view same pages; relevance can in this way be determined based on usage on all devices and it can be synchronized between devices.

When determining relevance of sections, also context of use may be taken into account, for instance some pages may be visited mostly at a certain time of a day. Other context criteria could be location, used access point (for instance big pages might be mostly used when WLAN connection is available) or nearby Bluetooth devices (for instance to determine if certain friends are around the user). The method may also analyse what kind of information the user is interested in (for instance, what kind of information web pages the user visits contain, what kind of information user's e-mails contain etc.) and analyse information of a page the user is using and, based on this, determine relevance of sections. Of course, determination of relevance may also be based on any combination of different criteria.

Furthermore, preference information from multiple sources may be combined; for instance sizes of sections presented in small-scale presentation may be set based on automatically collected relevance information, while font sizes of sections presented in large-scale presentation mode may be shown according to the values the user has manually set. Or page-specific values may be determined or set automatically, while certain site-specific or domain-specific values that may override page-specific values may be set by the user. Any other combination can be used, too. The used combination may also be set in preference information, or it may be automatically determined.

According to a further embodiment of the method of the present invention, said performing of changes to said set of sections to obtain said changed set of sections comprises at least reordering at least one section in said set of sections, and said reordering is performed via a drag-and-drop technique. This technique may for instance be implemented in combination with a touch screen that allows interaction with a stylus, or with a user interface such as a mouse, a track ball, a touch pad, a keyboard, a keypad or a track pin.

According to a further embodiment of the method of the present invention, said performing of changes to said set of sections to obtain said changed set of sections comprises at least reordering at least one section in said set of sections, and said reordering comprises selecting said at least one section for reordering; and moving a focus to a desired location in said set of sections for said at least one selected section.

According to a further embodiment of the method of the present invention, said preference information is represented by a search criterion. This may for instance be a keyword that is to be searched in said sections.

According to a further embodiment of the method of the present invention, said changes to said set of sections according to said preference information are performed by arranging said sections in said set of sections according to their relevance with respect to said search criterion.

Said sections may for instance be arranged with decreasing degree of match of their content and/or structure with respect to said search criterion, so that the best matching section is displayed in a preferred position, for instance a left topmost position or a centred position. Said search criterion may be defined before, during or after the retrieving of said page. It may also be advantageous to define said search criterion after said set of sections said page has been divided into has been displayed. It may be advantageous to define the same search criterion for a couple of pages, so that when retrieving the corresponding page objects, a search is automatically performed according to said search criterion, and the sections in said pages then are rearranged accordingly. It may however be advantageous not to store the changes applied to the set of sections in the context of said search, in order to avoid that upon the next request of said page, the same rearrangement is automatically performed again, although now a different search criterion or no search at all is desired.

According to a further embodiment of the method of the present invention, said preference information contains preference information that is associated with said page and is automatically retrieved upon said retrieving of said page object, and preference information that is represented by a search criterion.

Thus changes to said set of sections may be performed using both a search criterion and predefined change information at the same time. For instance, on a news page, navigation links to different news categories may be defined to be shown on the top, and sections in the centre column of a page may be defined to show in the order defined by a search criterion, to show news with the most interesting content first.

It is further proposed a computer program with instructions operable to cause a processor to perform the above-described method steps. Said computer program may for instance be executed in a central processing unit of a device on which said page is displayed, for instance a central processing unit of a PDA, lap-top computer or mobile phone. Equally well, said computer program may be executed by dedicated hardware in said device, for instance by a graphics processor or page interpreter.

It is further proposed a computer program product comprising a storage medium having a computer program with instructions operable to cause a processor to perform the above-described method steps embodied therein. Said computer program product may for instance comprise any storage medium suited for the at least temporary storage of said computer program, for instance a magnetic, electric or optic storage medium.

It is further proposed a device for generating a changed representation of a page object, wherein said page object is one of a page and a part of said page, said device comprising means arranged for retrieving said page object in response to a request for said page; means arranged for dividing said page object into a set of sections; and means arranged for performing changes to said set of sections according to preference information to obtain a changed set of sections representing said changed representation of said page object.

According to an embodiment of the device according to the present invention, said preference information is associated with said page, and said device further comprises means arranged for automatically retrieving said preference information upon said retrieving of said page object.

According to a further embodiment of the device according to the present invention, said means arranged for performing changes to said set of sections to obtain said changed set of sections comprises means arranged for performing at least one of reordering, zooming, hiding, deleting, reformatting and creating at least one section in said set of sections.

According to a further embodiment of the device according to the present invention, said device further comprises means arranged for presenting a representation of said changed set of sections.

According to a further embodiment of the device according to the present invention, said means arranged for presenting said representation of said changed set of sections comprises means arranged for presenting said changed set of sections in a small-scale presentation mode; means arranged for determining if said at least one section is selected by a user during said presenting of said changed set of sections in said small-scale presentation mode; and means arranged for presenting at least one section out of said changed set of sections in a large-scale presentation mode, if it is determined that said at least one section has been selected by a user during said presenting of said changed set of sections in said small-scale presentation mode.

According to a further embodiment of the device according to the present invention, said device further comprises means for automatically determining a user-related relevance of at least one section and for storing said relevance in said preference information.

According to a further embodiment of the device according to the present invention, said means arranged for dividing said page object into a set of sections implements a sectioning algorithm to divide said page object into said set of sections, and wherein said sectioning algorithm is based on element-wise rendering of elements of said page object and on appropriate combining of said rendered elements into said sections.

According to a further embodiment of the device according to the present invention, said means arranged for performing changes to said set of sections according to preference information to obtain a changed set of sections comprises at least means arranged for implementing a drag-and-drop technique to reorder at least one section in said set of sections.

According to a further embodiment of the device according to the present invention, said means arranged for performing changes to said set of sections according to preference information to obtain a changed set of sections comprises means arranged for selecting at least one section in said set of sections; and means arranged for moving a focus to a desired location in said set of sections for said at least one selected section in order to reorder said at least one section in said set of sections.

According to a further embodiment of the device according to the present invention, said preference information is represented by a search criterion.

According to a further embodiment of the device according to the present invention, said preference information contains preference information that is associated with said page and is automatically retrieved upon said retrieving of said page object, and preference information that is represented by a search criterion.

According to a further embodiment of the device according to the present invention, said device is one of a mobile phone, a personal digital assistant and a computer.

It is further proposed a system for generating a changed representation of a page object, wherein said page object is one of said page and a part of said page, said system comprising means arranged for retrieving said page object in response to a request for said page; means arranged for dividing said page object into a set of sections; means arranged for performing changes to said set of sections according to preference information to obtain a changed set of sections representing said changed representation of said page object. Said means of said system may be comprised in one device only, as for instance a mobile phone or an internet node, but may equally well be comprised in different devices, such as for instance in different nodes of a network (e.g. a telecommunications network).

These and other aspects of the invention will be apparent from and elucidated with reference to the embodiments described hereinafter.

### BRIEF DESCRIPTION OF THE FIGURES

In the figures show:

FIG. 1: A block diagram of an exemplary embodiment of a device and a system according to the present invention;

FIG. 2: a flowchart of an exemplary embodiment of a method according to the present invention;

FIG. 3: a flowchart of a further exemplary embodiment of a method according to the present invention;

FIG. 4a: an exemplary illustration of a set of sections a page has been divided into according to the present invention;

FIG. 4b: an exemplary illustration of a changed set of sections that is obtained by performing changes to the set of sections of FIG. 4a according to the present invention;

FIG. 4c: an exemplary illustration of a changed set of sections that is obtained by performing changes to the set of sections of FIG. 4a according to the present invention;

FIG. 4d: an exemplary illustration of a set of second-type sections that are obtained by dividing the changed set of sections of FIG. 4b according to the present invention;

FIG. 5a: an exemplary illustration of a displaying of the changed set of sections of FIG. 4b on a display in small-scale presentation mode according to the present invention;

FIG. 5b: an exemplary illustration of a displaying of one section out of the changed set of sections of FIG. 4b on a display in large-scale presentation mode according to the present invention;

FIG. 5c: an exemplary illustration of a displaying of one section out of the changed set of sections of FIG. 4b on a display in large-scale presentation mode together with further sections in small-scale presentation mode according to the present invention; and

FIG. 6: an exemplary flowchart of an embodiment of a sectioning algorithm according to the present invention.

### DETAILED DESCRIPTION OF THE INVENTION

The present invention proposes to generate a changed representation of a page object, which is either a page or a part of said page. Said changed representation of said page object may for instance be characterised by rearrangements and/or amendments of contents of said page object according to preference information. Said preference information may for instance have been defined by a user before, or may represent a search criterion according to which said rearrangements and/or amendments are performed. Said changed representation of said page object then may for instance be displayed on a display, stored or further processed. Said changed representation of said page object is generated by retrieving said page object in response to a request for said page, by dividing said page object into a set of sections, and by performing changes to said set of sections according to preference information to obtain a changed set of sections representing said changed representation of said page object.

In the following, the present invention will be described in more detail by means of exemplary embodiments. Therein, said page is exemplarily assumed to be a web page (for instance defined in the Hypertext Markup Language (HTML)) that is stored on an Internet server and requested by a user of a mobile phone with internet access capability by means of its Uniform Resource Locator (URL). In response to the request for the web page, the complete web page is exemplarily assumed to be retrieved (so that, in this exemplary case, the web page represents both the “page” and the “page object” as defined in the claims). Said web page is then divided into a set of sections, and, after changes have been performed to said set of sections, a representation of said changed set of sections is displayed on the display of said mobile phone, which display is comparatively small with respect to the dimensions of displays for which the web page is actually designed. It is however to be understood that the present invention is by no means restricted to deployment in the context of displaying web pages on displays of mobile phones only. The present invention can equally well be deployed to display all kinds of pages, as for instance text documents, presentation slides, application views, images, videos, 3D objects and any other type of information-carrying, visually perceivable object on all types of displays in all kinds of electronic devices.

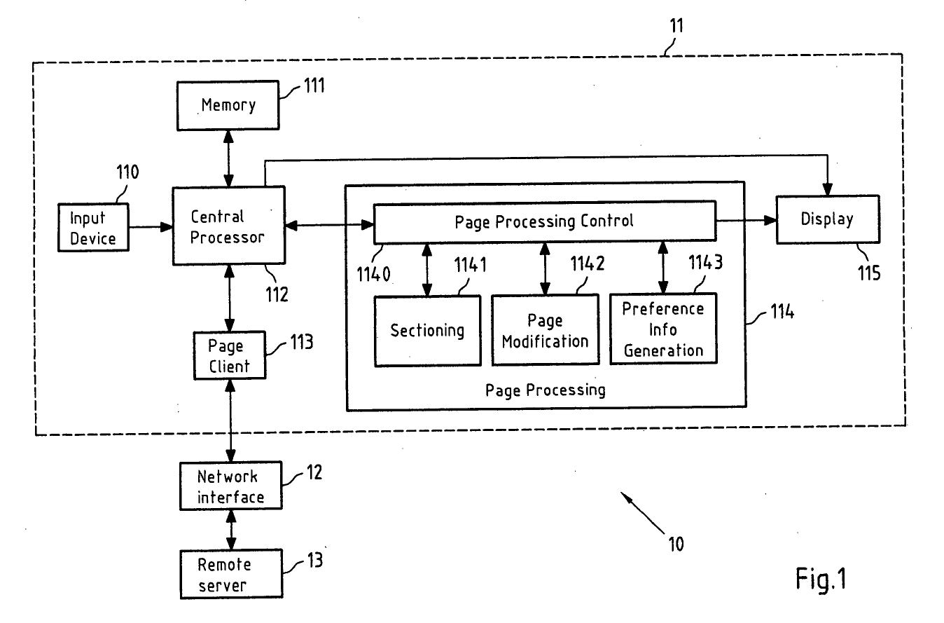

FIG. 1 depicts a block diagram of an exemplary embodiment of a device 11 and a system 10 according to the present invention.

The device 11, which may for instance be a mobile phone or a part thereof, comprises components required to implement a browser functionality. The central processor 112 controls the functions of the device and receives input from an input device 110, which may for example be embodied as a keypad, a touch-screen, a mouse, or a voice control instance. Via the input device 110, said central processor 112 receives a user's request for a page, for instance a web page being defined in the HTML format. Such a request may be formulated in terms of a URL indicating where the page can be found, wherein said request then may for instance be formulated by entering said URL via said input device 110, by selecting a bookmark that points to said URL or by selecting a hyperlink that is associated with said URL. Such a bookmark may for instance be stored in memory 111, to which the central processor has access. The central processor then uses the services of the page client 113, for instance an HTML client, wherein said services in particular comprise fetching of new pages via the network interface 12, which is connected to a remote server 13. In the exemplary embodiment of the present invention depicted in FIG. 1, this remote server 13 represents an Internet server, and as said device 11 is exemplarily taken to be a mobile phone, said network interface 12 comprises both the radio access network and the core network of a mobile communications system said mobile phone is operated in.

A page fetched in response to a user's request by the page client 113 is then forwarded by the central processor 112 to a page processing instance 114, which processes the page and prepares its displaying on a display 115, which is also controlled by said central processor 112.

The page processing instance 114 is controlled by a page processing control instance 1140. This instance controls the operation of a sectioning instance 1141, a page modification instance 1142 and a preference information generation instance 1143. Furthermore, the interaction of the page processing instance 114 with the central processor 112 and the display 115 is controlled by said page processing control instance 1140.

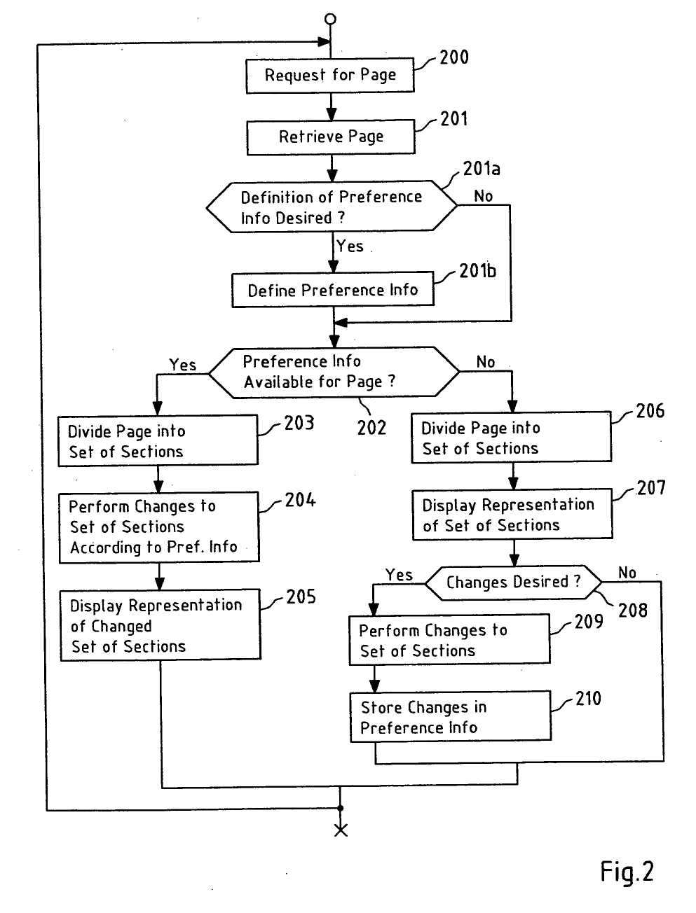

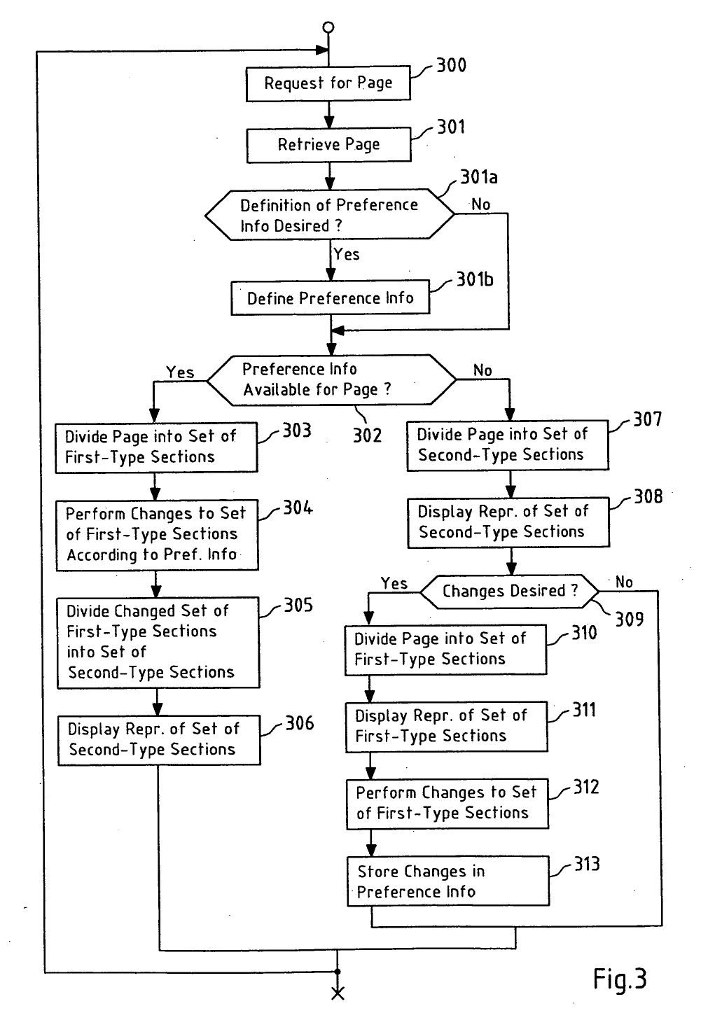

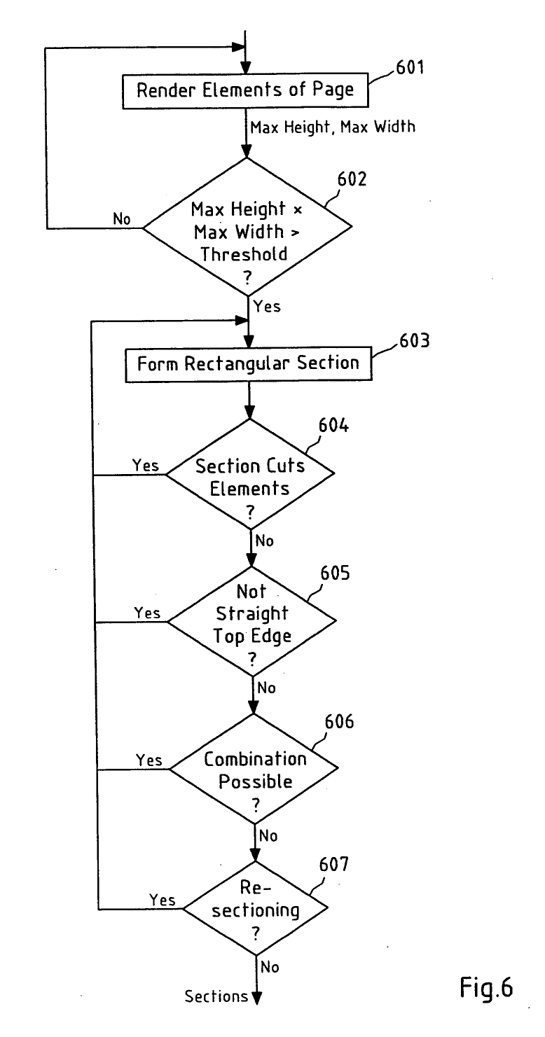

Said sectioning instance 1141 is arranged to divide pages into a set of sections, as will be described in more detail with reference to FIG. 6 below. Said page modification instance 1142 implements two-fold functionality: On the one hand, it allows a user to define changes of a page (in terms of sections), so that the changed page better fits his/her preferences, and on the other hand, it applies changes to a page (in terms of sections) as defined by preference information that is associated with said page. The detailed functionality of said page modification instance 1142 will become apparent from the description of the exemplary flowcharts of FIGS. 2 and 3 below. Said preference information generation instance 1143 finally allows changes that have been applied to a page (in terms of sections) by a user to be transformed into preference information. This preference information then may for instance be stored together with bookmark information for the page in the memory 111.

FIG. 2 depicts a flowchart of an exemplary embodiment of a method according to the present invention. In a first step 200, a page is requested by a user, for instance via the input device 110 of the device 11 of FIG. 1. The page is then retrieved in a step 201, which is accomplished by interaction of said central processor 112 (see FIG. 1), said page client 113, said network interface 12 and said remote server 13.

After step 201, it is checked in a step 201a if a user wants to define preference information for the requested and retrieved page, such as for instance a keyword or a search criterion. If this is the case, such a definition takes place in step 201b. Otherwise, no action is performed. For the following description, it is initially assumed that no preference information is defined in step 201b.

In step 202, it is checked if preference information is available for said page. This may for instance be checked by said central processor 112 (see FIG. 1) or said page processing control instance 1140. Preference information may for instance be stored together with bookmark information of said page in a bookmark, and if said page is requested via a bookmark, it can be checked if said bookmark contains preference information for said page. Equally well, there may exist a database in said memory 111 (see FIG. 1) that contains all preference information defined for pages so far and that is indexed with identifiers of said pages, for instance with their URLs.

If it is found in step 202 that no preference information is available for the requested and retrieved page, said page is divided into a set of sections in a step 206. This may be accomplished by means of a sectioning algorithm, that interprets and renders elements of the page and forms rectangular sections that contain these elements, as will be explained in more detail with reference to FIG. 6 below. The sectioning is performed in sectioning instance 1141 of the page processing instance 114 of FIG. 1.

A representation of said set of sections obtained in step 206 is then displayed in step 207 on the display 115 of the device 11 of FIG. 1. Said representation may for instance be a small-scale version of said set of sections that serves as a thumbnail index and fits the dimensions of the display, although the content of said sections then may be barely recognizable. Upon selection of sections in said thumbnail index, then the selected section may be shown in large-scale representation, which may for instance be a presentation in which said selected section is scaled to fit at least one dimension of the display, so that the content is better recognizable. Alternatively, said displayed representation of said set of sections may be an original layout representation, in which said sections substantially have a size (in pixels or inches) as prescribed by the page format, and then a lot of vertical and horizontal scrolling may be required to explore the contents of the complete page.

As an alternative to performing steps 206 and 207, it is also possible to directly display a representation of said page without sectioning. If changes shall be performed to the page, it is then still possible to divide said page into a set of sections later. This case is however not covered by the flowchart of FIG. 2.

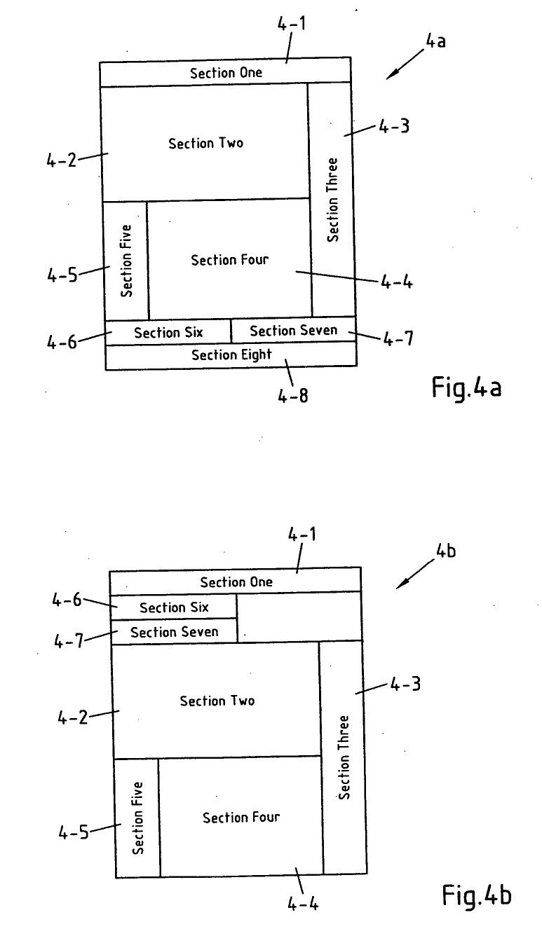

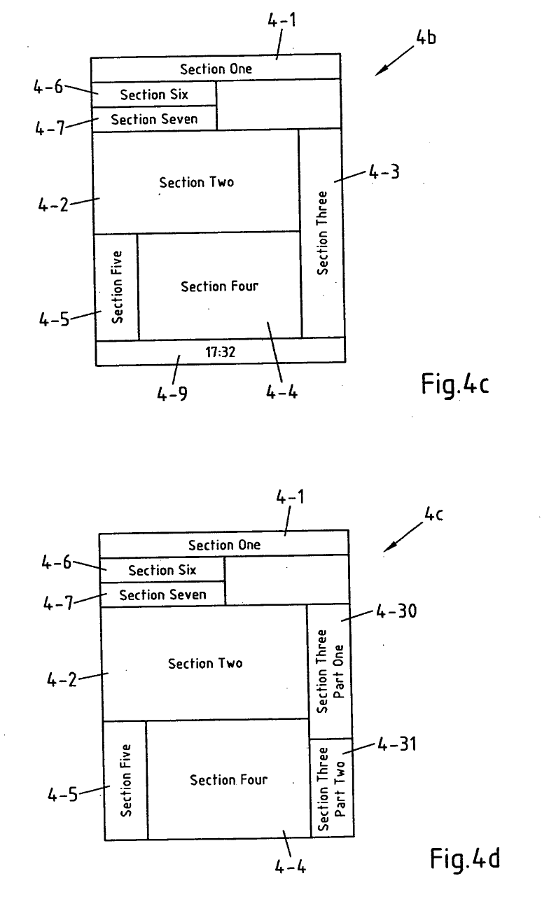

Returning to the flowchart of FIG. 2, if a user decides that, to adapt a page to his/her preferences, changes of said set of sections that page has been divided into are required (see step 208), such changes to said set of sections can be performed in step 209. Said changes may for instance comprise reordering, zooming, hiding, deleting, creating and reformatting sections of said set of sections, and the process of changing produces a changed set of sections. Illustrative examples of such changes will be given with reference to FIGS. 4a and 4b below. Said changes are handled by the page modification instance 1142 of the page processing instance 114 (see FIG. 1). Via the page processing control instance 1140 and the central processor 112, the page modification instance 1142 interacts with the input device 110 and processes the user's change requests. These change requests may for instance be performed by a drag-and-drop technique that is performed by the user on the displayed representation of said set of sections. Therein, sections may be selected and then moved to a desired new position, for instance based on the thumbnail representation of said set of sections. Of course, changes of sections like re-formatting of sections (e.g. re-formatting of the font size or background colour) and creating sections may require a more detailed displaying of said sections, for instance said above-mentioned large-scale presentation mode. Said drag-and-drop technique may be performed via a touch-screen display, or via a joystick, track-pin, track-ball, touch-pin, touch-pad, keyboard, keypad, voice control unit or similar interaction units. In any case, the user may be provided with visual feedback on his changes, i.e. the step 209 may also comprise a steady re-displaying of said representation of said changed set of changes (with said reordered/hidden/deleted/reformatted/created sections therein).

In a step 210, the changes performed by the user to said set of sections are stored as preference information. This preference information is generated by the preference information generation instance 1143 of the page processing instance 114 and may then be stored in the memory 111 of the device 11 (see FIG. 1). Said preference information may equally well be stored outside of said device 11, for instance on an Internet server, to be available to other users as well.

Said storage of said preference information may be triggered by a user command, or may be performed automatically. Said preference information may be stored together with bookmark information related to said page, for instance a URL of said page, or may be stored in a separate database, which may for instance be indexed with an identifier of the page.

Returning now to step 202, if it is decided, that preference information is available for the requested and retrieved page, said page is divided into a set of sections in a step 203. This may again be performed by the sectioning instance 1141 of the page processing instance 114 (see FIG. 1). The algorithm used for said division is advantageously the same algorithm as the one used in step 206, so that in both alternatives defined by the branching in step 202, the same set of sections is used.

Based on the preference information associated with said page, then changes are performed to said set of sections by the page modification instance 1142 of the page processing instance 114 (see FIG. 1). These changes may be performed automatically, or only after a user has agreed with the changes (a general agreement to such changes may for instance be declared in a menu topic offered by said device 11). According to the preference information, thus a reordering and/or zooming and/or hiding and/or deleting and/or reformatting and/or creating of sections in said set of sections is performed, and a changed set of sections is obtained. This changed set of sections then equals the changed set of sections that is obtained as a result of step 209.

In step 205, a representation of said changed set of sections is displayed on the display 115 of the device 11 (see FIG. 1). Said representation may for instance be a combination of a small-scale presentation mode of said changed set of sections, for instance as a thumbnail index, and a large-scale presentation mode of sections that are selected from said thumbnail index. Equally well, said changed set of sections may be displayed in a size that corresponds to the original layout size of said original set of sections, so that scrolling may be required to explore the entire content of the page. However, as user-defined modifications now have been performed to the page (in terms of sections), the amount of scrolling in both types of representation is significantly reduced, for instance because sections of interest have been grouped together and moved to a location in said set of sections that is initially displayed, for instance a topmost location.

After both steps 210 and 205, the flowchart returns to step 200 to allow for a request for a new page.

The present invention is at least partially based on the fact that, even though information content of web pages changes often, the basic structure of them remains the same for a long time. For instance, a web page may comprise an area in which a weather report is updated every day without substantially changing the size of said area, and sectioning of such a page then may substantially produce the same grid of sections. As, according to the present invention, the changes are defined and applied on a section basis, thus, even when the content of the sections changes during the definition (step 209) and the application of the changes (step 204) due to a change of the web page, reasonable results are achieved.

The discussion of the flowchart of FIG. 2 assumed that changes of a set of sections of a page are defined after a first request of said page (see step 209), and said changes, stored in preference information associated with said page, are then applied to said set of sections in response to a second request of said page (see step 204). According to the present invention, it is however also possible to define preference information in step 201b and then to perform changes to a set of sections during one and the same request. This case will now be considered. Therein, it is readily understood that the preference information can equally well be defined during the request for said page or before said request.

After the retrieving of a requested page in step 201, it is then determined in a step 201a if a user wants to define preference information. If this is the case, preference information can be defined by said user in said step 201a. This preference information may for instance be a keyword or other search criterion (for instance the presence of images or a text input field), which can be defined by the user via the input device 110 of said device 11 (see FIG. 1) under the control of said central processor 112. Said preference information then may be associated with an identifier of said requested and retrieved page, and may be stored in a memory 111, for instance together with bookmark information for said page. Equally well, said preference information defined by said user may be kept in a temporary memory and is erased after changes have been applied to said page. Said keyword or search criterion is to be automatically applied by said page processing instance 114 of the device 11 in FIG. 1 to said page.

Because preference information has been defined in said step 201b, the branching step 202 leads directly to step 203, in which said page is divided into a set of sections as explained above. Then, in step 204, changes are performed to said set of sections according to said preference information, which in this case is said keyword or search criterion. Said changes are performed by said page modification instance 1142 of said page processing instance 114 (see FIG. 1), which comprises a search engine and scans the sections in said set of sections for said keyword or search criterion. The sections in said set of sections then may for instance be reordered by said page modification instance 1142, so that sections that match said keyword or search string best are moved to preferred positions, for instance a left topmost position or a centre position, and so that sections with decreasing relevance with respect to said keyword or search criterion are then moved to positions with respectively decreasing preference. In step 205, then a representation of the changed set of sections, which is obtained by said reordering, is displayed on the display 115 of the device 11 (see FIG. 1), for instance by applying one of the display techniques described above.

The exemplary embodiments of the method of the present invention described with reference to FIG. 2 exemplarily assumed that, when said representation of said changed set of sections is displayed, a thumbnail index based on said changed set of sections in small-scale presentation mode and, upon selection of single sections in said thumbnail index, said selected sections in large-scale presentation mode are displayed. However, it may be advantageous to use a different sets of sections for defining (see step 209 of FIG. 2) and applying (see step 204) changes on the one hand, and for displaying the representation of said changed set of sections (see step 205) on the other hand.

FIG. 3 thus depicts an exemplary embodiment of the method of the present invention that uses a set of first-type sections for defining and applying changes to said page (in terms of sections) on the one hand, and a set of second-type sections for displaying said changed page (in terms of sections) on the other hand.

In a first step 300, the page is requested, and then retrieved in a step 301. Then it is checked in step 301a, if a user wants to define preference information (e.g. keywords or a search criterion), and if this is the case, such a definition is performed in step 301b. Again, it is initially assumed that no preference info is defined in step 301b.

If a check in step 302 reveals that no preference information is available for said page, said page shall first be displayed to the user, so that (s)he can perform changes. To this end, said page is divided into a set of second-type sections in a step 307, and a representation of said set of second-type sections is then displayed in a step 308. Therein, said dividing of said page into said set of second-type sections may aim at generating sections that, when shown in large-scale presentation, substantially do not exceed the dimensions of the display. In particular, long columns in a web page may be transformed into vertically stacked sections, so that said long columns are horizontally cut. When said set of second-type sections is displayed as thumbnail index in small-scale presentation mode, and if sections that are selected during said displaying in said small-scale presentation mode are then displayed in large-scale presentation mode, it may be more convenient that the sections said long column has been transformed into do not require vertical scrolling, because, when viewing of vertically adjacent content is desired, it can be switched to the small-scale presentation of said thumbnail image again, and therein, then the vertically adjacent section can be selected. Equally well, said displaying of said representation of said set of second-type sections may allow for section-wise scrolling, so that in the above-described case of said long column, for instance first the topmost section of said long column is displayed in large-scale presentation mode, and then the next lower sections can be explored by performing section-wise scrolling down in said large-scale presentation mode. In contrast, if said long column had been divided into one section only, line-wise scrolling down would be required to explore the entire content of said long column.

If said user wants to change the page that is displayed in step 308, which is checked for in step 309, said page is then divided into a set of first-type sections in step 310. In contrast to said sectioning performed in step 307, the sectioning in this step 310 may aim at generating first-type sections that are optimised for performing changes, and not necessarily for displaying. It thus may be targeted in the sectioning of step 310 to gather areas of said page that belong together due to their content into the same first-type section. A long column then would for instance be transformed into one section, which may then however exceed the dimensions of the display when being displayed in large-scale presentation mode.

Nevertheless, to allow the user to perform changes to said set of first-type sections, a representation of said set of first-type sections is displayed in step 311, for instance as a thumbnail index page in small-scale presentation mode. It is then again possible in step 312 for the user to perform changes, for instance to reorder and/or hide and/or delete and/or reformat and/or create sections to obtain a changed set of sections. Changes then can again be stored in step 313 automatically or upon user command in the preference information, for instance together with bookmark information.

If it is determined in step 302 that preference information is available for the requested page, in step 303 said page is then divided into a set of first-type sections (suited for defining/applying changes), and the changes as prescribed by the preference information are performed to said set of first-type sections by said page modification instance 1142 of the page processing instance 114 (see FIG. 1).

Said changed set of first-type sections then is divided into a set of second-type sections (suited for displaying) in step 305, and finally a representation of said set of second-type sections is displayed (either in small-scale presentation mode for a thumbnail index or a large-scale presentation mode of sections selected from said thumbnail index). As said second-type sections are displayed instead of said first-type sections, again a more convenient section-wise vertical scrolling may then be available in case of long columns.

Similar to the exemplary embodiment of the method of the present invention that was described with reference to FIG. 2, it is also possible with the exemplary embodiment of FIG. 3 that preference information, as for instance a keyword or a search criterion, is defined directly in step 301a without necessitating a previous request for a page, in which preference information is defined (see step 312) by performing changes to a set of sections said page has been divided into. Then in said step 304, said page modification instance 1142 of said page processing instance 114 performs changes to said set of first-type sections according to said keyword or search criterion, i.e. reordering said sections according to a degree of match of the content of said sections with said keyword or search criterion.

In the embodiment of the present invention described so far, it was assumed that the steps of retrieving said section in response to a request, dividing said page into a set of sections and performing changes to said set of sections to obtain said changed set of sections have to be performed in said device 11 of FIG. 1. However, said functionality may equally well at least partially be implemented in said network interface 12, said server 13 or any other remote unit or node. For instance, in said network interface 12, which comprises both a radio access network and a core network of a mobile communications system in case that said device 11 is a mobile phone, an instance may perform said dividing of pages that are passed across said network interface 12 into said set of sections and may also perform said changes on said set of sections to obtain said changed set of sections. Said changed set of sections then is lead to said device 11, where a representation of said set of sections is then displayed on the display 115.

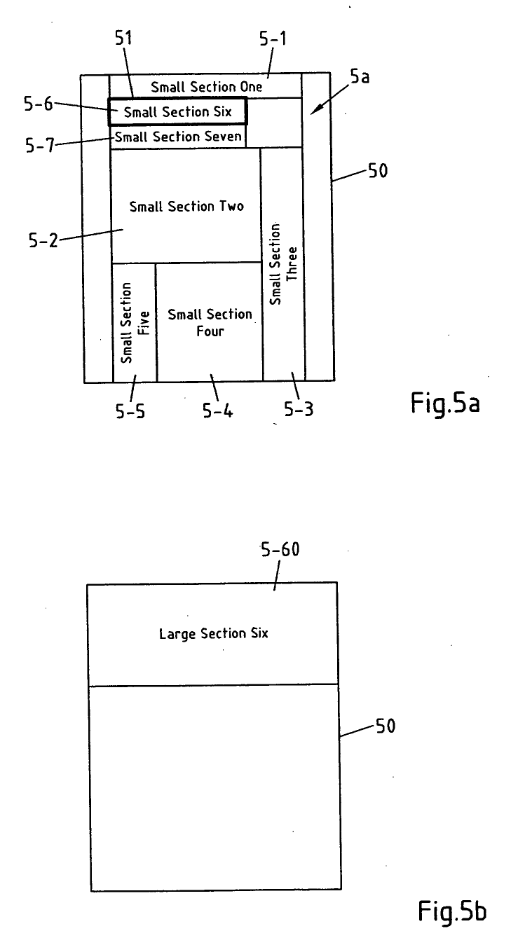

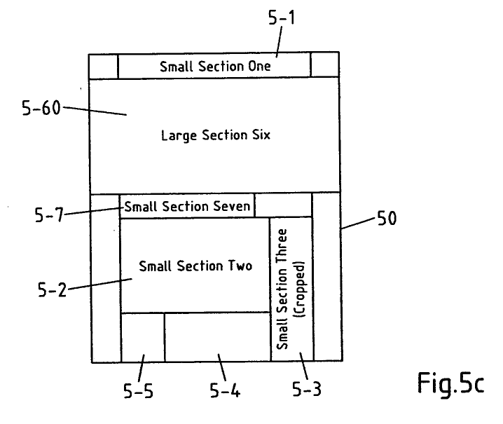

FIG. 4a depicts an exemplary illustration of a set 4a of sections 4-1 . . . 4-8 a page has been divided into according to the present invention. Said division of said page into said sections 4-1 . . . 4-8 may for instance have been performed by the sectioning algorithm that was applied in steps 206 and 203 of the flowchart of FIG. 2 and steps 303 and 310 of the flowchart of FIG. 3 to generate a set of (first-type) sections that is suited for defining/applying changes to a page. In said set 4a, section 4-8 may for instance comprise advertisements that are experienced as annoying by a user. Furthermore, sections 4-1, 4-6 and 4-7 contain information the user is particularly interested in, for instance a local weather report, a news ticker and a stock index, respectively. Even if said set 4a was displayed in small-scale presentation mode as thumbnail index, the user thus has to navigate a selection frame (see for instance the accentuation frame 51 in FIG. 5a) among the representations of said sections 4-1 . . . 4-8 in said thumbnail index to select sections that shall be displayed in large-scale presentation mode, and if the user wants to see the sections 4-1, 4-6 and 4-7, a lot of navigation in said thumbnail index is required due to the distance of said sections from each other. Similarly, if said set 4a of sections is displayed in an original layout mode, i.e. by far exceeds the dimensions of the display, a large amount of at least vertical scrolling is required to get from section 4-1 to section 4-6 and 4-7.

To overcome this problem, the user thus changes the set 4a of sections into a changed set 4b of sections, that is depicted in FIG. 4b. Therein, section 4-8 has been hidden (or deleted), and sections 4-6 and 4-7 have been moved to the top of the page, so that now sections 4-1, 4-6 and 4-7 are closely spaced and the amount of scrolling required to inspect their content is vastly reduced. It may also be imagined that a format of any of the sections 4-1 . . . 4-7 has been altered, for instance a background colour of section 4-4 may have been changed to increase readability of a text comprised. It is also possible according to the present invention to create a section that contains user-defined content, which may for instance be dynamically loaded from another page. Further possible changes to said set 4a of sections (see FIG. 4a) comprise, but are not limited to, changing the size of sections, assigning said sections different zoom factors, changing the aspect ratio, and cropping sections (without actually deleting them). The changes performed to said set 4a of sections that represents said page to obtain said changed set 4b of sections are stored in preference information which, according to the present invention, is automatically applied to said page (or more precisely, a set of sections said page has been divided into) when said page is again requested by a user. Thus the changes may only have to be performed once, and are automatically applied when the page is revisited. Of course, a user may reset the changes or turn off the automatic applying of said changes to said page, in particular, if the page is found to structurally change quite frequently.

The preference information stored to record the changes performed in said set 4a of sections to obtain said changed set 4b of sections may for instance be stored for a section. When a page is sectioned, an identifier (ID) may be given to a section. This may for example be done so that sections are numbered in the order they are generated by the sectioning algorithm, like #1 for the first section in the top left corner of a page, and #2, #3, etc. for the sections generated after that. In the preference information then, for a section, the following parameters may be stored after the changes to said set 4a of sections have been applied:
The order (or position) number of a section in the changed set 4b of sections, and/or a position (e.g. in coordinates) of the section in the changed set 4b of sections.
The formatting of the section: For instance zoom level, font size, background colour, font colour, etc.
The presence of the section, i.e. information whether the section is shown in said set 4b of sections or shall be hidden/deleted.
The size of the section, if the user adjusted the size, and information on a possible scaling/cropping of said section, if the user made the section smaller so that its content does no longer fit to it in normal size/normal aspect ratio.
For user-created sections, information on the contents of said sections, their formatting and their position. Possibly also some meta data which can be used to locate user-created section may be stored in said preference information, for instance the value of “id”-attribute of a <form> element that is in the user-created section, etc.

In the example of FIG. 4b, preference information then may for instance look like (assuming an order numbering starting in the left upper corner and increasing from left to right and top down):

Preference information for page

“www.pagetobechanged.com”:

Section One: Position #1

Section Two: Position #4

Section Three: Position #5

Section Four: Position #7

Section Five: Position #6

Section Six: Position #2

Section Seven: Position #3

Section Eight: Position None, deleted.

An example for preference information related to the creating of sections is depicted in FIG. 4c. Therein, the preference information entry

Application view One: Position #8, Type Clock

is appended to the above-listed preference information of FIG. 4b. In the changed set 4c of sections according to FIG. 4c, then a view of a clock application 4-9 of the device is added to the position eight. In addition to the clock application 4-9, of course a view or views from any application like a calendar etc. can be added to the changed set 4c of sections.

The preference information as defined for the two preceding examples is sufficient to enable said page modification instance 1142 of the page processing instance 114 (see FIG. 1) to apply the changes to a set of sections a re-visited page has been divided into, so that substantially the same changed set of sections is achieved (for instance in step 204 of the flowchart of FIG. 2) as during the definition phase of said changed set of sections (see for instance step 209 of the flowchart of FIG. 2).

It is readily understood that the preference information, when being directly defined as for instance in step 201b of the flowchart of FIG. 2, may have a different shape as in the example above. An example of such preference information may for instance be:

Preference information for page “www.pagetobechanged.com” Keyword : “UMTS Roll-out”

With such preference information, the page modification instance 1142 of the page processing instance 114 (see FIG. 1) then automatically searches sections the page has been divided into for matching content and reorders the sections accordingly. For instance, starting with the set 4a of sections as depicted in FIG. 4a, the set 4b of FIG. 4b may represent the result of such a reordering, if section 4-8 was still present at the bottom, and if sections 4-1, 4-6 and 4-7 contained text content that is related to the roll out of the UMTS system.

FIG. 4d depicts an exemplary illustration of a set 4d of second-type sections that are obtained by dividing the changed set 4b of (first-type) sections of FIG. 4b according to the present invention. As already discussed above, it may be advantageous to use different sectioning algorithms (or the same sectioning algorithm with different settings, as will be explained with reference to FIG. 6 below) to generate sets of sections for defining/applying changes to a page (in terms of sections) on the one hand and for displaying said page (in terms of sections) on the other hand. In FIG. 4d, the set 4b of first-type sections, that was generated from a page by a sectioning algorithm optimised for performing changes to said page (see step 310 or step 303 of the flowchart of FIG. 3) has been divided into a set of second-type sections (see step 305 of the flowchart of FIG. 2), but now with a sectioning algorithm optimised for displaying said page. The difference between the sets 4b and 4d of sections can be spotted when comparing section 4-3 in FIG. 4b and sections 4-30 and 4-31 in FIG. 4d. Section 4-3 represents a long column of a page with uniform content that was put into one section to allow said uniform content to be reordered/hidden/deleted/reformatted by a user. However, when said long column is to be displayed, it may be advantageous to vertically cut said long column to decrease the amount of scrolling required to entirely view said page, as already discussed above. To this end, first-type section 4-3 has been divided into two second-type sections 4-30 and 4-31 by the sectioning algorithm that is optimised for displaying said set 4d of sections.

FIGS. 5a and 5b illustrate how a representation 5a of a set of sections is displayed on a display area 50 of the display 115 of the device 11 of FIG. 1. Said representation 5a exemplarily assumes that one sectioning algorithm is used to divide a page into sections for defining/applying changes to a page (in terms of sections) and for displaying a representation of said page (in terms of sections), as it is described in the flowchart of FIG. 2. Representation 5a is thus a representation of the set 4b of sections 4-1 . . . 4-7 as depicted in FIG. 4b. This representation is simply said set 4b of sections 4-1 . . . 4-7 in small-scale presentation mode, i.e. the set 4b of sections has been scaled so that it fits at least one dimension of the display (in the present example this is the height of the display) and acts as a thumbnail index. In FIG. 5a, also an accentuation frame 51 is depicted, that can be navigated across the representations 5-1 . . . 5-7 of the sections 4-1 . . . 4-7 in the thumbnail index 5a to select a section. Selected sections then are displayed in large-scale presentation mode, as it is exemplarily depicted in FIG. 5b for section 5-60. In said large-scale presentation mode, said section 5-60 is enlarged as compared to said small-scale presentation mode, for instance so that it fits at least one dimension of the display (in this case the width of the display). Section-level scrolling may then be offered to a user, so that by scrolling one unit down, a large-scale representation of section 5-7 would be completely visible instead of the large-scale representation 5-60 of section 5-6.

It should be noted that, in said large-scale presentation mode, also further sections could be simultaneously be displayed in small-scale presentation mode, for instance sections 5-1 . . . 5-5 and 5-7. This scenario is exemplarily depicted in FIG. 5c. Note that sections 5-3 . . . 5-5 then can no longer completely be displayed in the display area 50 and thus are horizontally cropped. Their content may nevertheless be explored by vertical scrolling.

Equally well, representations of sections adjacent to section 5-6 (or any other sections) could be displayed in large-scale presentation mode as well, and then scrolling may be possible at a finer level than section level.

It should also be noted that, when displaying a representation of a set of sections, as for instance in step 205 of the flowchart of FIG. 2, not necessarily said thumbnail index of said set of sections in small-scale presentation mode has to be initially displayed. Equally well, first one of said sections could be displayed in said large-scale presentation mode. Information on the one or more sections that should first be displayed in said large-scale representation mode may be stored in said preference information. It may either be defined by a user, or be automatically determined, for instance depending on the frequency a user has selected said one or more sections for presentation in large-scale presentation before.

It is also possible that, when displaying said thumbnail index of said set of sections in small-scale presentation mode, the accentuation frame 51 (see FIG. 5a) is initially automatically placed on a section that is defined by the preference information, and this preference information may be either defined by a user or automatically determined based on the frequency of the selection of said section before.

FIG. 6 depicts a simplified exemplary flowchart of a sectioning algorithm for dividing a page into a set of sections according to the present invention. This algorithm may for instance be executed in steps 203 and 206 of the flowchart of FIG. 2 and in steps 303, 305, 307 and 310 of the flowchart of FIG. 3. The sectioning algorithm can be used to produce sets of sections that are both suited as a basis for defining/applying changes to a page (in terms of sections) and as a basis for displaying a page (in terms of sections). The different settings required to achieve this two-fold functionality of the sectioning algorithm will be explained in the following.

In step 601 of the flowchart of FIG. 6, elements contained in a page that is to be divided into a set of sections are element-wise rendered and investigated in the order they appear in the source code of said page. If said page is a web page defined in HTML, said elements may for instance be HTML elements (e.g. images). In said step 601, calculation of pixel values corresponding to said elements is for instance performed as if a page was shown in its original layout with 100% zoom factor. As a result, a maximum height and a maximum width in pixels related to a number of rendered elements is obtained.

In a step 602, it is then checked if the product of said maximum height and said maximum width is larger than a pre-defined threshold, for instance 100,000 pixels. If this is the case, a rectangular section containing the elements rendered in step 601 is formed in a step 603. Otherwise, the step 601 of rendering elements of said page is continued until the condition of step 602 is met.

In a step 603 (and also in step 602), when forming a section (i.e. calculating the display area in pixels that the created section would take), table areas having no information content (no text, no images, no input fields or similar) may not be taken into account (i.e. may not be included into the section). In other words, within tables, sections are formed according to information content in the order in which said information content appears in the page source code (e.g. HTML, XHTML or similar source code).

In a step 604, it is then checked if a lower edge of said formed section would vertically cut an element of said page that cannot be divided (for instance an HTML <image>, or an HTML <object>). If this is the case, forming a section according to step 603 is retried so that the last element tried to be included at the last time in step 603 is not included anymore. This procedure is repeated until it leads to a lower edge of said section that does not cut any element of said page. In addition to elements that cannot be cut, this procedure may also be applied to paragraphs (HTML tags <p>, <div>) and forms (HTML tag <form>) and small tables (HTML tag <table>).

This step may be performance-optimized by iterating first in bigger steps, and then element by element when new section edges are almost found.

According to step 603, it may be advantageous to leave a small padding between section borders and content, so that section borders and content do not touch even if a section is focused with an accentuation frame.

In a step 605, it is checked whether said formed section would not have a straight top edge. If this is the case, the algorithm returns to step 603 and tries to form a new section with a straight top edge. For example, if the first element for a section is vertically in the middle of a left table column, and the next element would be at the top of the right table column, the end of a section should be created before the element that would make the top edge not straight.

If this is not the case, opportunities for combining sections are checked in a step 606 according to one or more of the following rules:

If the width of a section matches that of a previous section, if these two sections are horizontally similarly positioned, and if the number of pixels of a combined section obtained when these two section are taken together is less than a threshold, for instance 150,000 pixels, then these two sections are combined.

Furthermore, if forming sections would create empty space below sections, this empty space is combined with one or more sections above it, by vertically extending a section above it by a required amount. In this special case, the empty space is not taken into account when checking a condition for re-sectioning in a step 607, as will be explained below.

If this procedure of vertically extending sections to avoid empty spaces still leaves empty space between sections, vertical borders of sections are horizontally moved, so that empty space disappears (i.e. becomes included into sections). In this special case, too, empty space is not taken into account when checking a condition for re-sectioning in a step 607.

Finally, in a step 607, it is checked if re-sectioning of said formed section is necessary, wherein in case of re-sectioning, the step 603 is again performed to form a new rectangular section.

For instance, if the number of pixels of a formed section gets bigger than a threshold, for instance 300,000 pixels, after its creation (for example because of a script adding content or arrival of big image elements), re-sectioning is done for that section and sections after it.

Similarly, if all content of a formed section disappears after its creation (because of a script or external cascading style sheets), re-sectioning is done for that section and sections after it.

As a result of the algorithm of FIG. 6, a set of sections is output.

The above-described exemplary flowchart for a sectioning algorithm may be further refined by the following features:

If an absolute size of an image is set in a source code of the page, placeholders of that size may be rendered instead of said image in said step 601. If a size is not set (nor has been received yet with an image file), in said step 601 said image may be assumed to be of fixed size, for instance 50 pixels high and 100 pixels wide.

If a script writes a sequence of elements to a page, that whole sequence added by a script is kept inside the same section.

If the number of pixels of an element of the page that cannot be divided into smaller pieces (for instance an HTML <img> or HTML <object>) is larger than a threshold, for instance 300,000 pixels, an own section may always be created for that element. The height of that section would be the height of the element, the left edge would be next to a section on the left (or edge of canvas if there is no section on the left), and the right edge would be next to a section on the right (or edge of canvas if there is no section on the right). In addition to elements that cannot be divided, this rule may also be applied to big paragraphs (HTML tags <p>, <div>) and big forms (HTML tag <form>).

If an element is hidden by using cascading style sheets, but if it is still set to reserve corresponding space for itself using cascading style sheets, in said step 603 of forming rectangular sections it is handled as if it was visible (i.e. it is taken into account when calculating said section).

It is readily understood that the steps of the above-presented sectioning algorithm can basically also be applied for dividing 3D pages into sets of 3D sections, if in step 601, 3D elements, such as for instance Virtual Reality Markup Language (VRML) elements are rendered, if in step 602, the product of the maximum width, height and depth is checked against a threshold, and if in step 603, the section formed is a parallelepiped. The steps of checking if said 3D section cuts 3D elements, has non-straight edges, can be combined or requires re-sectioning then can be performed analogously. In this algorithm, it may be advantageous to allow that the 3D sections can slightly overlap with each other to provide nicer transitions. If the 3D page does not possess a hierarchical structure that allows for the above-described sectioning algorithm, the 3D page may simply be divided into a plurality of 3D sections of fixed size, for instance into a plurality of cubes.

The sectioning algorithm described so far tends to divide long columns into several vertically adjacent sections and may therefore be suited to divide a page into a set of second-type sections, i.e. a set of sections a representation of which is to be displayed on a display (see step 305 and 307 of the flowchart of FIG. 3). To allow for this sectioning algorithm to be used in the steps 203 and 206 of the flowchart of FIG. 2 and the steps 303 and 310 of the flowchart of FIG. 3, i.e. to divide a page into a set of first-type sections that may serve as a basis for the defining and applying of changes to a page (in terms of sections), only a minor modification in step 606 of the flowchart of FIG. 6 is required.

In particular, the following rule is included into step 606: If vertically adjacent sections are equally wide, and if their left and right edges are horizontally similarly positioned, these sections are combined irrespective of the size the combined section gets. This re-verses the division of a long column into several vertically adjacent sections. This rule can for instance be switched on or off by setting a flag, and then basically the same sectioning algorithm (with said flag being turned on or off) can be used to generate said sets of first-type and second-type sections. It is readily clear that, if said rule is fixedly implemented into the sectioning algorithm of FIG. 6, said sectioning algorithm can be used in the flowchart of FIG. 2, where no differentiation between sets of first-type and second-type sections is made.

The invention has been described above by means of exemplary embodiments. It should be noted that there are alternative ways and variations which are obvious to a skilled person in the art and can be implemented without deviating from the scope and spirit of the appended claims. In particular, the present invention is not necessarily restricted to deployment in the context of small displays. Changing representations of page is also of advantage when representations of pages that are displayed on computer or television screens or projectors can be changed based on preference information as proposed by the present invention.

What is claimed is:

1. A method for generating a changed representation of a page object, wherein said page object is one of a page and a part of said page, said method comprising:
retrieving said page object in response to a request for said page;
dividing said page object into a set of sections; and
performing changes to said set of sections according to preference information to obtain a changed set of sections representing said changed representation of said page object.

2. The method according to claim 1, wherein said preference information is associated with said page and is automatically retrieved upon said retrieving of said page object.

3. The method according to claim 1, wherein said preference information is stored together with bookmark information concerning said page.

4. The method according to claim 1, wherein said changes to said set of sections according to said preference information are performed automatically.

5. The method according to claim 1, wherein said page is requested at least two times, wherein in response to a first request, a defining of said preference information is performed, and wherein in response to a second request, said steps of retrieving said page object, dividing said page object into said set of sections, and performing changes to said set of sections to obtain said changed set of sections are performed.

6. The method according to claim 1, wherein said performing of changes to said set of sections to obtain said changed set of sections comprises at least one of reordering, zooming, hiding, deleting, reformatting and creating at least one section in said set of sections.

7. The method according to claim 1, wherein a sectioning algorithm is used to divide said page object into said set of sections, and wherein said sectioning algorithm is based on element-wise rendering of elements of said page object and on appropriate combining of said rendered elements into said sections.

8. The method according to claim 1, further comprising:
presenting a representation of said changed set of sections.

9. The method according to claim 8, wherein said presenting of said representation of said changed set of sections comprises:
presenting said changed set of sections in a small-scale presentation mode ; and
presenting at least one section out of said changed set of sections in a large-scale presentation mode, if said at least one section is selected by a user during said presenting of said changed set of sections in said small-scale presentation mode.

10. The method according to claim 8, wherein in said presenting of said representation of said changed set of sections, at least one section out of said changed set of sections is accentuated, and wherein said at least one accentuated section is a relevant section that is specified in said preference information.

11. The method according to claim 1, wherein a user-related relevance of at least one section is automatically determined and stored in said preference information.

12. The method according to claim 1, wherein said performing of changes to said set of sections to obtain said changed set of sections comprises at least reordering at least one section in said set of sections, and wherein said reordering is performed via a drag-and-drop technique.

13. The method according to claim 1, wherein said performing of changes to said set of sections to obtain said changed set of sections comprises at least reordering at least one section in said set of sections, and wherein said reordering comprises:
selecting said at least one section for reordering; and
moving a focus to a desired location in said set of sections for said at least one selected section.

14. The method according to claim 1, wherein said preference information is represented by a search criterion.

15. The method according to claim 14, wherein said changes to said set of sections are performed by arranging said sections in said set of sections according to their relevance with respect to said search criterion.

16. The method according to claim 1, wherein said preference information contains preference information that is associated with said page and is automatically retrieved upon said retrieving of said page object, and preference information that is represented by a search criterion.

17. A computer program with instructions operable to cause a processor to perform the method steps of claim 1.

18. A computer program product comprising a storage medium having a computer program with instructions operable to cause a processor to perform the method steps of claim 1 embodied therein.

19. A device for generating a changed representation of a page object, wherein said page object is one of a page and a part of said page, said device comprising:
a page client configured to retrieve said page object in response to a request for said page;
a sectioning instance configured to divide said page object into a set of sections; and
a page modification instance configured to perform changes to said set of sections according to preference information to obtain a changed set of sections representing said changed representation of said page object.

20. The device according to claim 19, wherein said preference information is associated with said page, and wherein said device further comprises:
means arranged for automatically retrieving said preference information upon said retrieving (201; 301) of said page object.

21. The device according to claim 19, wherein said page modification instance configured to perform changes to said set of sections to obtain said changed set of sections comprises:
means arranged for performing at least one of reordering, zooming, hiding, deleting, reformatting and creating at least one section in said set of sections.

22. The device according to claim 19, further comprising:
a display configured to present a representation of said changed set of sections.

23. The device according to claim 22, wherein said means arranged for presenting said representation of said changed set of sections comprises:
means arranged for presenting said changed set of sections in a small-scale presentation mode;
means arranged for determining if said at least one section is selected by a user during said presenting of said changed set of sections in said small-scale presentation mode; and
means arranged for presenting at least one section out of said changed set of sections in a large-scale presentation mode, if it is determined that said at least one section has been selected by a user during said presenting of said changed set of sections in said small-scale presentation mode.

24. The device according to claim 19, further comprising means for automatically determining a user-related relevance of at least one section and for storing said relevance in said preference information.

25. The device according to claim 19, wherein said sectioning instance configured to divide said page object into a set of sections implements a sectioning algorithm to divide said page object into said set of sections, and wherein said sectioning algorithm is based on element-wise rendering of elements of said page object and on appropriate combining of said rendered elements into said sections.

26. The device according to claim 19, wherein said page modification instance configured to perform changes to said set of sections according to preference information to obtain a changed set of sections comprises at least means arranged for implementing a drag-and-drop technique to reorder at least one section in said set of sections.

27. The device according to claim 19, wherein said page modification instance configured to perform changes to said set of sections according to preference information to obtain a changed set of sections comprises:
means arranged for selecting at least one section in said set of sections; and
means arranged for moving a focus to a desired location in said set of sections for said at least one selected section in order to reorder said at least one section in said set of sections.

28. The device according to claim 19, wherein said preference information is represented by a search criterion.

29. The device according to claim 19, wherein said preference information contains preference information that is associated with said page and is automatically retrieved upon said retrieving of said page object, and preference information that is represented by a search criterion.

30. The device according to claim 19, wherein said device is one of a mobile phone, a personal digital assistant and a computer.

31. A system for generating a changed representation of a page object, wherein said page object is one of a page and a part of said page, said system comprising:
means arranged for retrieving said page object in response to a request for said page;
means arranged for dividing said page object into a set of sections;
means arranged for performing changes to said set of sections according to preference information to obtain a changed set of sections representing said changed representation of said page object.
